(19) United States
(12) Patent Application Publication
(10) Pub. No.: US 2010/0153786 A1
(43) Pub. Date: Jun. 17, 2010

(54) Processor, multiprocessor, and debugging method

(75) Inventor: Kazuya Matsukawa, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/591,881

(22) Filed: Dec. 3, 2009

(30) Foreign Application Priority Data
Dec. 11, 2008 (JP) 315591/2008

(51) Int. Cl. G06F 11/36

(52) U.S. Cl. 714/38; 714/E11.21

(57) ABSTRACT

A processor, a multiprocessor, and a debugging method for solving the conventional problems, one of which is very difficult to switch among debug programs and start the selected program within a certain time. The above convention problem can be solved by a processor that includes a debug unit block, a multimode debug interrupt control block, and an execution block. The debug unit block monitors the execution of the debug target user program and issues a debug interrupt when a predetermined debug condition is satisfied. The control block, upon receiving such a debug interrupt, specifies a debug mode that selects a predetermined debug program. When the debug unit block issues such a debug interrupt, the execution block selects and executes a debug program according to the debug mode specified by the control block.

### FIELD OF THE INVENTION

The present invention relates to a processor, a multiprocessor, and a debugging method.

### BACKGROUND OF THE INVENTION

In recent years, along with the appearance of highly enhanced and high performance vehicle control units and mobile phones, the software of the microcomputers built in those units and devices have been expanded in scale and become complex in function. And in order to debug the software programs of those built-in microcomputers, task debuggers have been developed so as to efficiently cope with debugging of tasks on their operating systems (OS) respectively. A task debugger sets break points in the debug target task, thereby stopping the task and check the memory contents, etc. at each of those set break points.

There is a well-known invention that provides such a task debug function, as well as a system debug function that stops the while target system. JP-A-2006-079261 discloses such an invention “Program Debugging Method”. According to the invention, a debugger sends a debug command to a target system that includes two debug programs. When the target system receives the debug command, a monitor management program of the system switches between those two debug monitoring programs. This method can realize both of task debugging that stops only the target task and system debugging that stops the whole system in the same debugging environment.

### SUMMARY

Control object systems of such built-in type microcomputers are very complicated. A debugging method referred to as bypass emulation is usually employed for debugging in order to develop such control object systems efficiently; part of the object algorithm is executed by an externally provided alternative high performance general computer in this case.

FIG. 1 shows a diagram for describing such bypass emulation. As shown in FIG. 1, the bypass emulation uses an external computer to bypass some processings. If a break is detected in the bypass emulation, control is passed to an alternative program (debug program) from the user program. The microcomputer then executes the alternative program and outputs the input values of the bypass processings to the external computer (STEP 00). The external computer then executes [processing 1], [processing 2], and [processing 3] respectively and returns the results of those processings to the microcomputer. The microcomputer then executes the alternative program and fetches the operation results output from the external computer (STEP 99). Here, the alternative program returns control to the user program.

Under such circumstances, there has been a demand for constructing a debugging environment so as to realize a debug function that executes such bypass emulation, as well as other debug functions. According to the technique disclosed in the JP-A-2006-079261, however, it has been confronted with a problem that it is very difficult to execute such bypass emulation within a fixed time. In case of the technique disclosed in the JP-A-2006-079261, for example, when switching is made from system debugging to task debugging, the user is required to operate the debugger to send the object debug command. Furthermore, in the target system, the monitoring management program is required to switch between the two debug programs. Therefore, the bypass emulation cannot be started before the switching by the monitoring management program is ended. As a result, the response is delayed so much, thereby it becomes very difficult to keep normal operations in the control object system.

Furthermore, in case of the technique disclosed in the JP-A-2006-079261, when one debug program is switched to the other, the user is required to operate the debugger to send the debug command. Consequently, the user is further required to operate the debugger properly to determine which specific part of the object user program should be related to its corresponding specific debug program. And this is why it has been impossible to relate a specific operation in the user program to bypass emulation. This has been a problem.

Furthermore, in case of the multiprocessor type microcomputer, one processor executes one user program while the other processor executes the other user program.

Consequently, if the technique of the JP-A-2006-079261 is applied to such a multiprocessor type microcomputer, it is very difficult to assure matching between the debug mode of one processor and the debug mode of the other processor. This is why the technique cannot cope with the simultaneous breaking (also referred to as a synchronous breaking) to be executed in such a multiprocessor type microcomputer so easily.

Hereunder, there will be described “means for solving the problem” with reference to the numbers/reference numerals used in “best mode for carrying out the invention”. Those numbers/reference numerals are put in parentheses to clarify the correspondence between the description of “what is claimed is” and the description of “the best mode for carrying the invention”. Those numbers/reference numerals cannot be used to describe the technical field of the invention described in “what is claimed is”.

The processor in the first aspect of the present invention includes a debug unit block (B2), a multimode debug interrupt control block (B6), and an execution block (B7). The debug unit block (B2) monitors the execution of a user program to be debugged and issues a debug interrupt to the user program when a predetermined debug condition is satisfied. The multimode debug interrupt control block B6, upon receiving the debug interrupt, specifies a debug mode used to select a predetermined debug program. The execution block B7 then selects and executes a debug program according to the debug mode specified by the multimode debug interrupt control block B6 when the debug unit block B2 issues a debug interrupt to the user program.

The processor in the second aspect of the present invention includes one processor (B100-1) having the above first aspect property and another processor (B100-2).

The multimode debug interrupt control block (B106-1) of the processor (B100-1), if a debug interrupt is generated in the processor (B100-1), specifies the same debug mode as that of the processor (B100-1) for the multimode debug interrupt control block (B106-2) in the processor (B100-2) and sends a simultaneous break interrupt that executes a simultaneous debug interrupt to the control block (B106-2). The multimode debug interrupt control block (B106-2) of the processor (B100-2), when receiving the specified debug mode and a simultaneous break interrupt from the multimode debug interrupt control block (B106-1) in the processor (B100-1), executes the debug interrupt in another processor (B100-2) and specifies the same debug mode as that in one processor (B100-1) for the execution block (B7-2) in another processor (B100-2).

The debug method in the third aspect of the present invention includes: applying a debug interrupt; specifying a debug mode, and executing the debug mode. In the applying of a debug interrupt, in the processor (B0), the execution of the user program to be debugged is monitored and a debug interrupt is issued to the user program when a predetermined debug condition is satisfied. In the specifying of a debug mode, in the processor (B0), a debug mode used to select a predetermined debug program is specified in response to the received debug interrupt. In the executing of a predetermined debug program, in the processor (B1), a predetermined debug program is selected and executed in the debug mode specified in response to the received debug interrupt.

According to the present invention, it is therefore possible to prepare plural debug modes and quickly switch to a predetermined debug program.

### BRIEF DESCRIPTION OF THE DRAWINGS

FIG. 1 is a block diagram for describing bypass emulation;

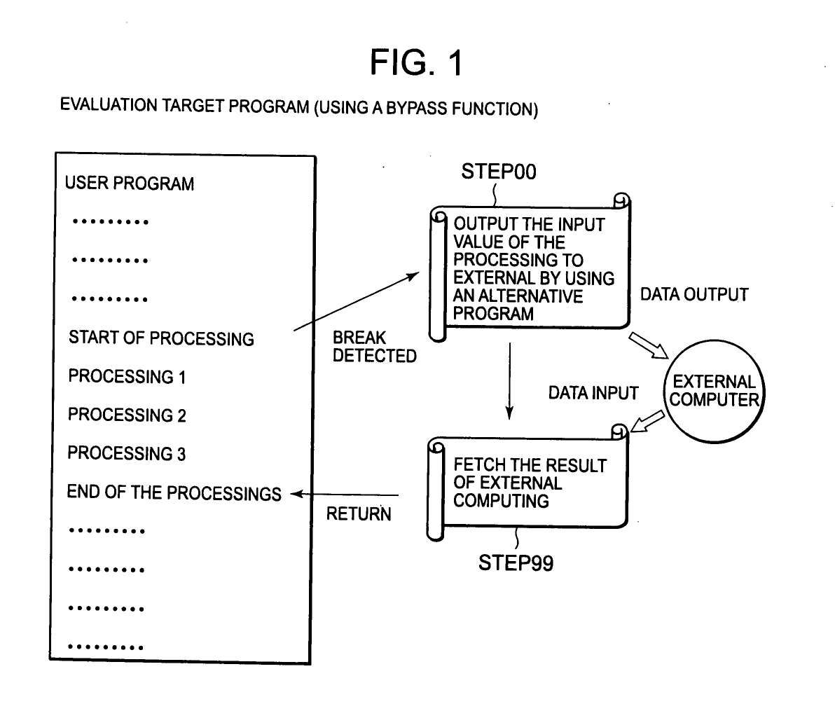

FIG. 2 is a block diagram for describing a configuration of a processor in an embodiment;

FIG. 3 is a block diagram for describing a configuration of the processor B0 in the first embodiment;

FIG. 4 is a block diagram for describing a detailed configuration of a multimode debug interrupt control block;

FIG. 5 is a block diagram for describing a detailed configuration of an execution block;

FIG. 6 is a block diagram for describing a configuration of a multiprocessor in the second embodiment; and

FIG. 7 is a block diagram for describing a configuration of a multimode debug interrupt control block corresponding to the multiprocessor in the second embodiment.

### DETAILED DESCRIPTION OF THE PREFERRED EMBODIMENTS

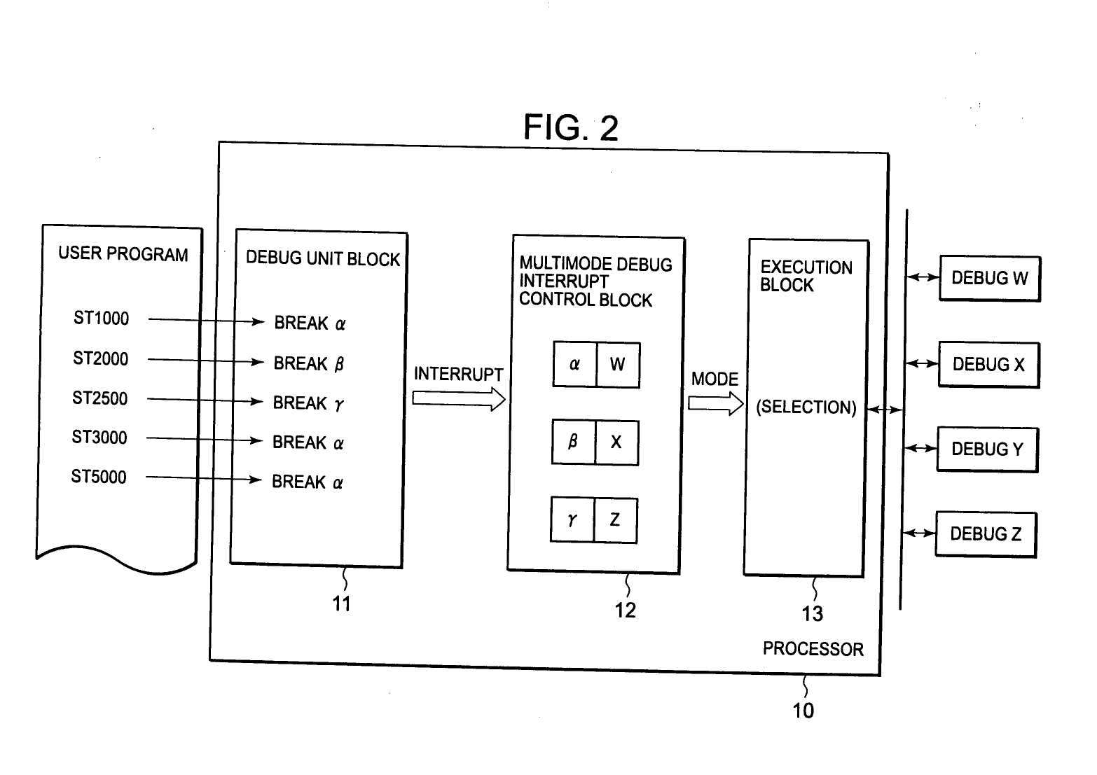

Hereunder, there will be described a preferred embodiment of the present invention with reference to the accompanying drawings. FIG. 2 is a block diagram for describing a configuration of a processor in one of the embodiments of the present invention. In FIG. 2, one or plural debug conditions (hereunder, also to be referred to as break points/break conditions) can be set in the user program. In FIG. 2, five break points are set. Each break point can be related to a predetermined debug program. A processor 10 corresponds to plural debug modes and can access any of memory areas that store plural types of debug programs W, X, Y, and Z, respectively.

As shown in FIG. 2, the processor 10 in this embodiment includes a debug unit block 11, a multimode debug interrupt control block 12, and an execution block 13. The debug unit block 11 monitors the execution of the user program. The debug unit block 11, when detecting a set break point, issues a debug interrupt corresponding to the break point. In FIG. 2, three types of debug interrupts α, β, and γ are defined. The multimode debug interrupt control block 12, when accepting a debug interrupt from the debug unit block 11, specifies the debug mode corresponding to the debug interrupt type. The execution block 13 then selects and executes a debug program according to the specified debug mode.

For example, if the user program developer operates an operation for setting a break α in the 1000th step in the user program as shown in FIG. 2, the debug unit block 11 stores the set content and issues the debug interrupt α when the 1000th step is executed. The multimode debug interrupt control block 12 stores the data denoting the correspondence of each debug program to the debug interrupt “α” beforehand. Therefore, when accepting the debug interrupt α, the control block 12 specifies the debug mode of the debug program W according to the specified data. The execution block 13 then selects and executes the debug program W in the specified debug mode.

### First Embodiment

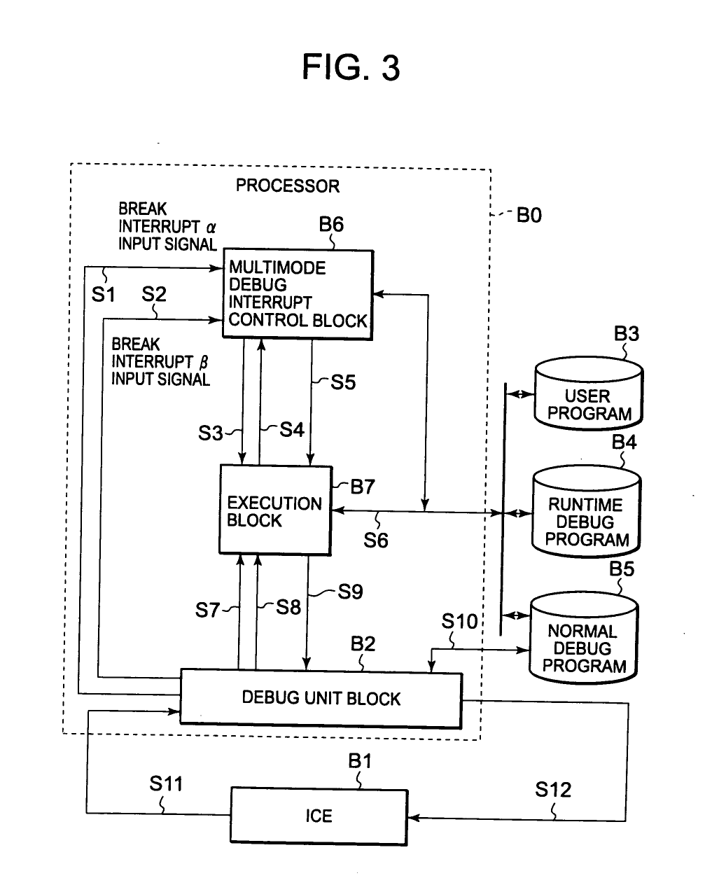

Hereunder, there will be described the embodiments of the present invention in detail. FIG. 3 is a block diagram of a processor B0 with respect to its configuration employed in the first embodiment. As shown in FIG. 3, the processor B0 includes a multimode debug interrupt control block B6, an execution block B7, and a debug unit block B2. In FIG. 3, ICE (In-Circuit Emulator (registered trademark)) B1 denotes an external unit to be operated by the user.

In FIG. 3, the debug unit block B2 controls the resources provided in the processor B0 according to the instruction, etc. received from the ICE B1 to realize the object debug function. The debug unit block B2 communicates with the ICE B1 and uses an ICE interface input signal S11 and an ICE interface output signal S12 to set a debug condition for the user program. In the debug unit block B2 in this first embodiment are set two types of debug conditions (one debug condition x for generating the first type break interrupt α and the other debug condition y for generating the second type break interrupt 1). The debug unit block B2 monitors the user program executed by the execution block B7 and issues a break interrupt a to the program if the debug condition x is satisfied and issues a break interrupt β to the program if the debug condition y is satisfied.

The execution block B7 has functions for selecting and executing any one of the debug object user program, the runtime debug program for bypass emulation, and the normal debug program. The execution block B7, upon receiving a break interrupt request signal S3, selects the address of the runtime debug program storage area B4 or the normal debug program storage area B5 according to the break interrupt factor information S5. Then, branching to the selected address, the execution block B7 fetches and executes the object debug program instruction.

The multimode debug interrupt control block B6 can accept plural types of break interrupts. In this first embodiment, there are prepared two types of break interrupts; α and β. The multimode debug interrupt control block B6, when accepting the first type break interrupt α, controls so as to execute one of the two debug programs. When accepting the second type break interrupt β, the multimode debug interrupt control block B6 controls so as to execute one of the two debug programs. The control block B6 uses the outputted break interrupt factor information S5 for those controls. And according to this break interrupt factor information S5, the control block B6 specifies a debug mode for selecting the object debug program.

In FIG. 3, the debug object user program is created by the user himself/herself and stored in the user program storage area B3. The runtime debug program is used to execute debug processings that require quick responses, such as bypass emulation, etc. The runtime debug program is stored in a runtime debug program storage area B4. The normal debug program is a program that is not required to be started within a certain time limitation, for example, like the execution of bypass emulation. The program is usually stored in a normal debug program storage area B5. The processor B0 in this first embodiment selects one of the addresses of the three program storage areas B3, B4, and B5 and fetches the instruction from the selected address and executes the instruction.

### <<Operations>>

### [Initialization by ICE]

When debugging a program in the processor B0 in this first embodiment, the user operates the ICE B1 before executing the debug target user program to set various necessary items in the processor B0. At first, the user activates the debug unit block B2 with use of an ICE interface input signal S11. When the debug unit block is activated in such a way, the debug unit enable signal S7 is activated.

Next, the user sets the data denoting the correspondence between the type of the break interrupt and the debug program for the multimode debug interrupt control block B6. Then, the user transfers the program used to set the correspondence data from the ICE B1 to the normal debug program data storage area B5 through the lines of the ICE interface input signal S11 and the access bus signal S10. After this transfer completes, the debug unit block B2 sends the execution block control signal S8 denoting the completion of the transfer and the start of the execution to the execution block B7. When the execution block B7 starts up the program for setting with use of the system bus signal S6, the correspondence data is set in the multimode debug interrupt control block B6. In this first embodiment, the break interrupt α is related to the runtime debug program while the break interrupt 13 is related to the normal debug program.

The debug unit block B2 accepts and sets each break condition according to the ICE interface input signal S11. Plural break conditions can be set and either the first type break interrupt α or the second type break interrupt β can be set for each of those break conditions. In this first embodiment, two break conditions x and y are set for the user program. When the break condition x is satisfied, the break interrupt α is executed and when the break condition y is satisfied, the break condition β is executed.

### [Starting Up the User Program]

When the user completes the initialization with use of the ICE B1, the debug unit block B2 sends an execution block control signal S8 to the execution block B7. The signal S8 denotes the start of the user program execution. The execution block B7 then selects the address of the user program storage area B3 and starts the execution of the user program. While the execution block B7 is executing the user program, the debug unit block B2 keeps monitoring the execution block sate signal S9 sent from the execution block B7. Detecting that the subject break condition is satisfied, the debug unit block B2 issues a predetermined break interrupt according to the setting.

### [Operations to be Executed in Response to the Condition of a Detected Runtime Break Interrupt]

If the debug unit block B2 detects that the break condition x is satisfied, a break interrupt α is issued. Then, the multimode debug interrupt control block B6 receives a break interrupt a input signal S1 from the debug unit block B2. Receiving the signal S1, the multimode debug interrupt control block B6 outputs a break interrupt request signal S3 to the execution block B7. At the same time, the control unit B6 refers to the set correspondence data and outputs the break interrupt factor information S5 that specifies the debug mode corresponding to the runtime debug program to the execution block B7.

The execution block B7 thus receives the break interrupt request signal S3 and the break interrupt factor information S5 from the multimode debug interrupt control block B6. Accepting the break interrupt, the execution block B7 returns a break interrupt acceptance complete signal S4 to the control unit B6. The control unit B6, upon receiving the break interrupt acceptance complete signal S4, turns off the break interrupt request signal S3.

Then, the execution block B7 fetches the instruction from the address of the runtime debug program storage area B4 according to the break interrupt factor information S5 and executes the runtime debug program. The execution block B7 switches from the user program to the runtime debug program quickly; here, none of the ICE B1 and the debug unit block B2 are required for the switching.

### [Operations to be Executed in Response to the Condition of a Detected Normal Break Interrupt]

If the debug unit block B2 detects that the break condition y is satisfied, a break interrupt β is issued. At this time, the multimode debug interrupt control block B6 receives a break interrupt β input signal S2 from the debug unit block B2. Receiving this break interrupt β input signal S2, the control unit B6 outputs a break interrupt request signal S3 to the execution block B7. At the same time, the control unit B6 refers to the set correspondence data and outputs the break interrupt factor information S5 that specifies the debug mode corresponding to the normal debug program to the execution block B7.

The execution block B7, upon receiving the break interrupt request signal S3 and the break interrupt factor information S5, fetches the instruction from the address of the normal debug program storage area B5 and makes an attempt for executing the normal debug program. At this time, if the execution block control signal S8 enables the access to the normal debug program storage area B5, the execution block B7 fetches the instruction from the address of the normal debug program storage area B5 and executes the normal debug program right away.

On the other hand, if the execution block control signal S8 disables the access to the normal debug program storage area B5, the execution block B7 suspends the execution of the program. The user then operates the ICE B1 to load the normal debug program that includes the function to the normal debug program storage area B5 and resets the access disabled by the execution block control signal S8. The execution block B7 then fetches the instruction from the address of the normal debug program storage area B5 and executes the loaded normal debug program. When executing the normal debug program for the second time or later, the normal debug program that is already loaded into the normal debug program storage area B5 may be used or another normal debug program is overwritten in the normal debug program storage area B5 so as to use the normal debug program that comes to have different functions.

As described above, in this first embodiment, the runtime break interrupt or the normal break interrupt is selected and executed automatically in accordance with the execution of the user program. Furthermore, the runtime debug program or the normal debug program is selected and executed automatically in accordance with the execution of the user program. Here, no user operation is required for any of those selections and executions.

### <<Detailed Configuration of the Multimode Debug Interrupt Control Block>>

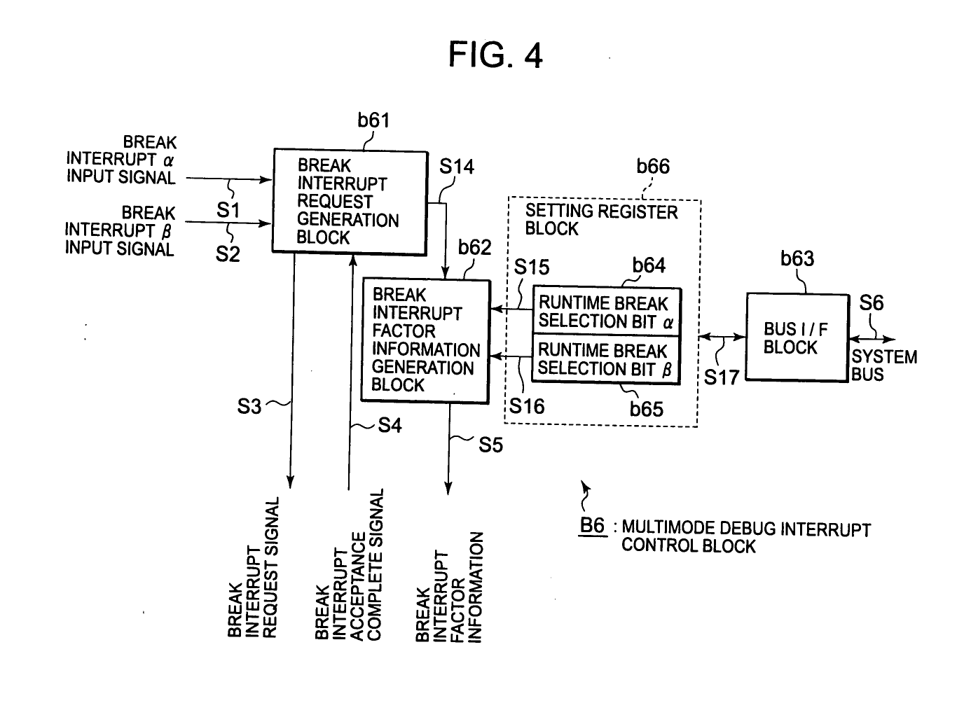

FIG. 4 is a block diagram for describing the detailed configuration of the multimode debug interrupt control unit. As shown in FIG. 4, the multimode debug interrupt control block B6 in the first embodiment includes a break interrupt request generation block b61, a break interrupt factor information generation block b62, a setting register block b66, and a bus interface block b63. The setting register block b66 includes a runtime break selection bit α holding block b64 corresponding to the break interrupt α and a runtime break selection bit 3 holding block b65 corresponding to the break interrupt β.

The runtime break selection bit α and the runtime break selection bit 3 are set at the initialization time respectively. The setting program is started up first, and then corresponding data is written in the setting register unit b66 according to the system bus signal S6, the bus interface unit b63, and the internal access bus signal S17. In this first embodiment, the runtime debug program is related to the break interrupt α and the normal debug program is related to the break interrupt β. Therefore, “1” is written in the runtime break selection bit a holding block b64 and “0” is written in the runtime break selection bit β holding block b65. In other words, when “1” is set in the runtime break selection bit, the debugging is executed in the runtime debug mode. And when “0” is set in the runtime break selection bit, no debugging is executed in the runtime debug mode.

### [Operations to be Executed in Response to the Condition of a Detected Runtime Break Interrupt]

In the multimode debug interrupt control block B6, the break interrupt request generation block b61 receives the break interrupt alpha input signal S1. The break interrupt request generation block b61 then generates a break interrupt request signal S3 and outputs the signal S3 to the execution block B7. At this time, the block b61 generates a break interrupt type signal S14 and outputs the signal S14 to the break interrupt factor information generation block b62. The break interrupt factor information generation block b62 then generates the break interrupt factor information S5 according to the break interrupt type signal S14 and the runtime break selection bit α output signal S15 that notifies the content of the runtime break selection bit α holding block b64. Because “1” is set in the runtime break selection bit α here, the break interrupt factor information S5 output to the execution block B7 specifies the runtime debug mode. After this, when receiving the break interrupt acceptance complete signal S4 from the execution block B7, the break interrupt request generation block b61 turns off the break interrupt request signal S3.

### [Operations to be Executed in Response to the Condition of a Detected Normal Break Interrupt]

In the multimode debug interrupt control block B6, the break interrupt request generation block b61 receives the break interrupt β input signal S2. The break interrupt request generation block b61 then generates a break interrupt request signal S3 and outputs the signal S3 to the execution block B7. At this time, the block b61 also generates a break interrupt type signal S14 and outputs the signal S14 to the break interrupt factor information generation block b62. The break interrupt factor information generation block b62 generates the break interrupt factor information S5 according to the break interrupt type signal S14 and the runtime break selection bit β output signal S16 that notifies the content of the runtime break selection bit β holding block b65 and outputs the information S5 to the execution block B7. Because “0” is set in the runtime break selection bit β at this time, the break interrupt factor information S5 output to the execution block 87 specifies the normal debug mode. After this, receiving the break interrupt acceptance complete signal S4 from the execution block B7, the break interrupt request generation block b61 turns off the break interrupt request signal S3.

### <<Detailed Configuration of the Execution Block>>

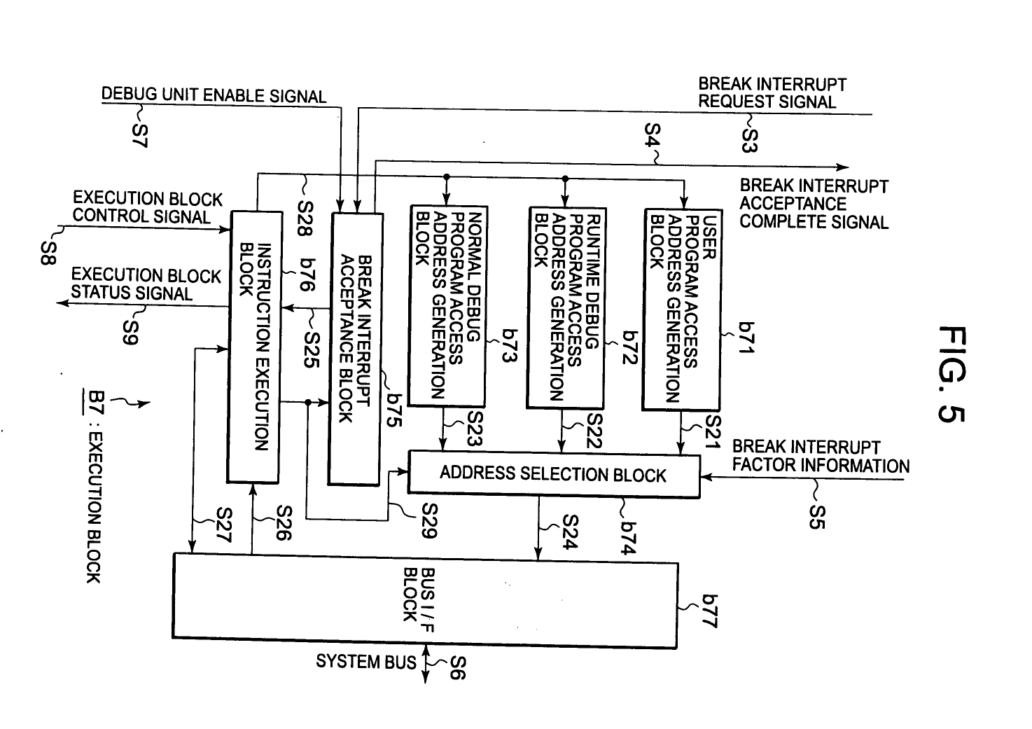

FIG. 5 is a block diagram for describing the configuration of the execution block. As shown in FIG. 5, the execution block B7 includes a user program access address generation block b71, a runtime debug program access address generation block b72, a normal debug program access address generation block b73, an address selection block b74, a break interrupt acceptance block b75, an instruction execution block b76, and a bus interface block b77.

The break interrupt acceptance block b75, upon receiving a debug unit enable signal S7 from the debug unit block B2, is activated to accept a break interrupt request signal S3. If accepting the break interrupt request signal S3 in this status, the break interrupt acceptance block b75 refers to the instruction execution block status signal S29. If the instruction execution block status signal S29 denotes that the debug program is being executed (break status), the break interrupt acceptance block b75 suspends the acceptance of the break interrupt.

On the other hand, if the instruction execution block status signal S29 denotes that the user program is being executed (user status), the break interrupt acceptance block b75 accepts the break interrupt and outputs a break interrupt acceptance signal S25 to the instruction execution block b76. After this, if the instruction execution block b76 changes the status of the instruction execution block status signal S29 to denote the break status, the break interrupt acceptance block b75 outputs a break interrupt acceptance complete signal S4 to the multimode debug interrupt control block B6.

The instruction execution block b76 outputs an instruction request signal S28 and inputs an instruction fetch bus signal S26 to fetch the object instruction. The instruction request signal S28 includes the information denoting whether the instruction execution block b76 is in the user status or in the break status. As a result of the execution of the fetched instruction, if a data access is generated, the instruction execution block b76 fetches the object data through the data access bus signal S27 line, the bus interface block b77, and the system bus signal S6 line.

Upon receiving the execution block control signal S8, the instruction execution block b76 is enabled to receive commands to start and stop instruction executions from the debug unit block B2. Furthermore, the instruction execution block b76 sends an execution block sate signal S9 to notify the debug unit block B2 of the progress of the program execution. And the instruction execution block b76, upon receiving the break interrupt acceptance signal S25 from the break interrupt acceptance block b75, shifts the status from user status to break status and changes the content of the instruction execution block status signal S29 from user status information to break status information.

The user program access address generation block b71 generates an address to access the user program according to the instruction request signal S28 and outputs the first address information S21 denoting the address of the user program storage area B3. The runtime debug program access address generation block b72 generates an address for accessing the runtime debug program according to the instruction request signal S28 and outputs the second address information S22 denoting the address of the runtime debug program storage area B4. The normal debug program access address generation block b73 generates an address for accessing the normal debug program according to the instruction request signal S28 and outputs the third address information S23 that denotes the address of the normal debug program storage area B5.

The address selection block b74 selects one of the first address information S21, the second address information S22, and the third address information S23 according to the instruction execution block status signal S29 and the break interrupt factor information S5. The address selection block b74 then outputs the selected address information S24 to the bus interface block b77. If the instruction execution block status signal S29 denotes the user status, the address selection block b74 selects the first address information S21. If the instruction execution block status signal S29 denotes the break status and if the break interrupt factor information S5 denotes the runtime debug mode respectively, the address selection block b74 selects the second address information S22. If the instruction execution block status signal S29 denotes the break status and if the break interrupt factor information S5 denotes the normal debug mode respectively, the address selection block b74 selects the third address information S23.

### <<Operations in the Detailed Configuration>>

### [Initialization]

If the instruction execution block b76 fetches and executes an instruction for writing to the runtime break selection bit α holding block b64 or an instruction for writing to the runtime break selection bit β holding block b65 in the multimode debug interrupt control block B6, the write access is enabled through the data access bus signal S27 line, the bus interface block b77, and the system bus signal S6 line. The write data to appear in the line of the system bus signal S6 is fetched into the bus interface block b63 in the multimode debug interrupt control block B6. Then, the writing to the setting register unit b66 is done through the line of the internal bus signal S17.

### [Operations in the User Status]

While the user status is set, the execution block B7 is active and the multimode debug interrupt control block B6 is inactive. In this case, the following operations will be executed in order:

1. The instruction execution block b76 adds the user status information to the instruction request signal S28 and outputs the signal S28. Here, the instruction execution block b76 also outputs an instruction execution block status signal S29 that denotes the user status.

2. The user program access address generation block b71 outputs the first address information S21 according to the instruction request signal S28. The runtime debug program access address generation block b72 and the normal debug program access address generation block b73 are both inactive, since the user status denoting information is added to the instruction request signal S28.

3. The address selection block b74 selects the first address information S21 from among the first address information S21, the second address information S22, and the third address information S23 according to the received instruction execution block status signal S29 and outputs the selected address information S24.

4. The bus interface block b77 generates an instruction fetch request access according to the selected address information S24 and outputs the access signal to the line of the system bus signal S6. In addition, receiving an instruction of the user program through the line of the system bus signal S6, the bus interface block b77 outputs the instruction to the line of the instruction fetch bus signal S26.

5. The instruction execution block b76 executes the instruction fetched through the line of the instruction fetch bus signal S26. Then, the instruction execution block b76 outputs the progress status of the instruction execution to the line of the execution block status signal S9.

### [Operations to be Executed in Response a Runtime Break Interrupt Generated in the User Status]

While the execution block B7 is executing the user program, if the multimode debug interrupt control block B6 receives a break interrupt a input signal S1 from the debug unit block B2, the following operations are to be executed:

1. The break interrupt request generation block b61 outputs a break interrupt request signal S3 to the execution block B7. The break interrupt request generation block b61 also outputs a break interrupt type signal S14 to the break interrupt factor information generation block b62. The signal S14 denotes that the interrupt input signal is a break interrupt a input signal S1.

2. The break interrupt factor information generation block b62 outputs the break interrupt factor information S5 that specifies the runtime debug mode to the address selection block b74 according to the break interrupt type signal S14 and the runtime break selection bit alpha output signal S15. Because “1” is set for the runtime break selection bit α at this time, the runtime break selection bit α output signal S15 specifies the runtime debug mode.

3. The break interrupt acceptance block b75, upon accepting the break interrupt request signal S3, outputs a break interrupt acceptance signal S25 to the instruction execution block b76.

4. The instruction execution block b76, upon receiving the break interrupt acceptance signal S25, changes the internal status from user status to break status. Then, the instruction execution block b76 outputs an instruction execution block status signal S29 to the break interrupt acceptance block b75 and the address selection block b74 respectively. Furthermore, the instruction execution block b76 also outputs an instruction request signal S28 having added status information of “now in the break status” to those blocks.

5. The break interrupt acceptance block b75, when confirming that the status of the instruction execution block status signal S29 has been changed from user status to break status, initializes the internal status and outputs a break interrupt acceptance complete signal S4 to the break interrupt request generation block b61.

6. The runtime debug program access address generation block b72 and the normal debug program access address generation block b73, upon receiving an instruction request signal S28 having added status information of “now in the break status”, generate the second address information S22 and the third address information S23 and output them to the address selection block b74 respectively. The user program access address generation block b71 makes no operation at this time, since the instruction request signal S28 denotes “now in the break status”.

7. The address selection block b74 selects the second address information S22 from among the first, second, and third address information items S21 to S23 according to the instruction execution block status signal S29 denoting the break status and the break interrupt factor information S5 that specifies the runtime debug mode. Then, the address selection block b74 outputs the second address information S22 to the bus interface block b77 as the selected address information S24.

8. The bus interface block b77 generates an instruction fetch request access signal with use of the selected address information S24 and outputs the access signal to the destination as a system bus signal S6. After this, the subject instruction is read from the runtime debug program storage area B4 and output to the line of the system bus signal S6. The bus interface block b77 reads this instruction.

9. The read instruction is passed to the instruction execution block b76 through the line of the instruction fetch bus signal S26. Thus the runtime debug program instruction is executed.

### [Operations to be Executed in Response to a Normal Break Interrupt Issued in the User Status]

While the execution block B7 is executing the user program, if multimode debug interrupt control block B6 receives a break interrupt β input signal S2 from the debug unit block B2, the interrupt will be processed as follows:

1. The break interrupt request generation block b61 outputs a break interrupt request signal S3 to the execution block B7. Furthermore, the break interrupt request generation block b61 outputs a break interrupt type signal S14 to the break interrupt factor information generation block b62. The signal S14 denotes that the interrupt input signal is a break interrupt beta input signal S2.

2. The break interrupt factor information generation block b62 outputs the break interrupt factor information S5 that specifies the normal debug mode to the address selection block b74 according to the break interrupt type signal S14 and the runtime break selection bit output signal S16. Because “0” is set for the runtime break selection bit β at this time, the runtime break selection bit β output signal S16 specifies the normal debug mode.

3. The break interrupt acceptance block b75, upon accepting the break interrupt request signal S3, outputs a break interrupt acceptance signal S25 to the instruction execution block b76.

4-1. The instruction execution block b76, upon receiving the signal S25, changes the internal status from user status to break status. The instruction execution block b76 then outputs the instruction execution block status signal S29 to the break interrupt acceptance block b75 and the address selection block b74 respectively. Furthermore, the instruction execution block b76 outputs the instruction request signal S28 having added status information of “now in the break status” to those blocks b75 and b74.

4-2. When the status of the instruction execution block b76 is changed to the break status, if the execution block control signal S8 disables the access to the normal debug program storage area B5, the instruction execution block b76 waits for the instruction request signal S28 having added status information of “now in the break statue” for a certain time, then outputs the signal S28. Meanwhile, the user operates the ICE B1 to load the normal debug program having a desired function into the normal debug program storage area B5 and resets the access having been disabled by the execution block control signal S8.

5. The break interrupt acceptance block b75, upon confirming that the status of the instruction execution block status signal S29 is changed from user status to break status, initializes the internal status and outputs a break interrupt acceptance complete signal S4 to the break interrupt request generation block b61.

6. The runtime debug program access address generation block b72 and the normal debug program access address generation block b73, upon receiving an instruction request signal S28 having added status information of “now in the break status”, generate the second address information S22 and the third address information S23 and output those information items to the address selection block b74 respectively. The user program access address generation block b71 makes no operation at this time, since the instruction request signal S28 denotes “now in the break status”.

7. The address selection block b74 selects the third address information S23 from among the first, second, and third address information items S21 to S23 according to the instruction execution block status signal S29 denoting the break status and the break interrupt factor information S5 that specifies the normal break mode. Then, the address selection block b74 outputs the third address information S22 to the bus interface block b77 as the selected address information S24.

8. The bus interface block b77 generates an instruction fetch request access signal with use of the selected address information S24 and outputs the access signal to the destination as a system bus signal S6. After this, the signal S6 is read from the normal debug program storage area B5 and output to the line of the system bus signal S6. The bus interface block b77 reads this instruction.

9. The read instruction is passed to the instruction execution block b76 according to the instruction fetch bus signal S26. Thus the normal debug program instruction is executed.

### Effects of the First Embodiment

As described above, in this first embodiment, whether a break interrupt is issued when a predetermined debug condition is satisfied is determined automatically and quickly so as to be used as a quickly responsible runtime break interrupt or as a normal break that does not require a quick response but can realize an enhanced debug function. This can thus quicken start of the execution of the debug program. Furthermore, because the address of the debug program storage area can be selected as described above, branching to the object debug program can be made instantaneously.

### Second Embodiment

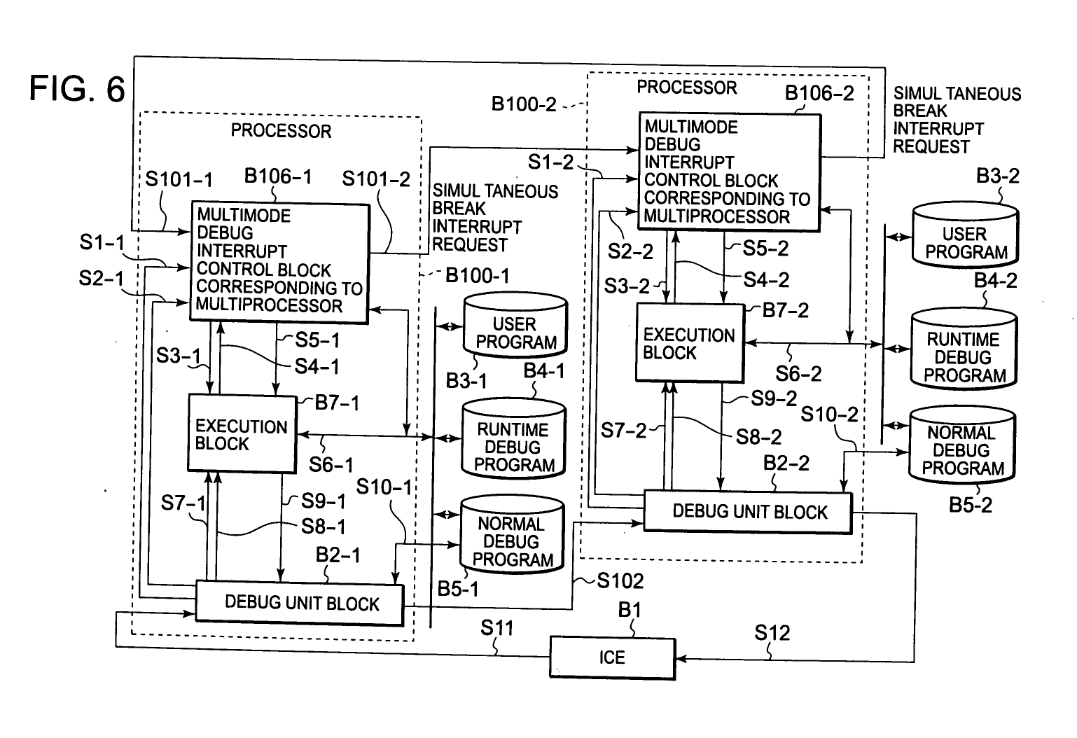

FIG. 6 is a block diagram for describing a configuration of a multiprocessor in this second embodiment. As shown in FIG. 6, the multiprocessor in this second embodiment includes two processors B100-1 and B100-2 that are the same in configuration as that of the processor B0 in the first embodiment. In FIG. 6, the debug unit block B2-1 of the processor B100-1 and the debug unit block B2-2 of the processor B100-2 are the same in function and in configuration as that of the debug unit block B2 of the processor B0 in the first embodiment. The execution block B7-1 of the processor B100-1 and the execution block B7-2 of the processor B100-2 are the same in function and in configuration as that of the execution block B7 of the processor B0 in the first embodiment.

The ICE B1 shown in FIG. 6 is the same as the ICE B1 shown in FIG. 3 and the ICE interface input signal S11 and the ICE interface output signal S12 can be used to set the two debug unit blocks B2-1 and B2-2. When setting the debug unit block B2-1, the inter-unit bock signal S102 is passed through the debug unit block B2-2 and changed to an ICE interface output signal S12. When setting the debug unit block B2-2, the ICE interface input signal S11 is passed through the debug unit block B2-1 and changed to an inter-unit block signal S102 to be inputted to the debug unit block B2-2.

The break interrupt a input signals S1-1 and S1-2, the break interrupt β input signals S2-1 and S2-2, the break interrupt request signals S3-1 and S3-2, the break interrupt acceptance complete signals S4-1 and S4-2, the break interrupt factor information items S5-1 and S5-2, the system bus signals S6-1 and S6-2, the debug unit enable signals S7-1 and S7-2, the execution block control signals S8-1 and S8-2, the execution block status signals S9-1 and S9-2, and the access bus signals S10-1 and S10-2 are also the same in function as the break interrupt a input signal S1, the break interrupt 3 input signal S2, the break interrupt request signal S3, the break interrupt acceptance complete signal S4, the break interrupt factor information item S5, the system bus signal S6, the debug unit enable signal S7, and the execution block control signal S8, the execution block status signal S9, and the access bus signal S10 in the first embodiment respectively.

The user program storage areas B3-1 and B3-2, the runtime debug program storage areas B4-1 and B4-2, and the normal debug program storage areas B5-1 and B5-2 are also the same in function as the user program storage area B3, the runtime debug program storage area B4, and the normal debug program storage area B5 in the first embodiment, respectively.

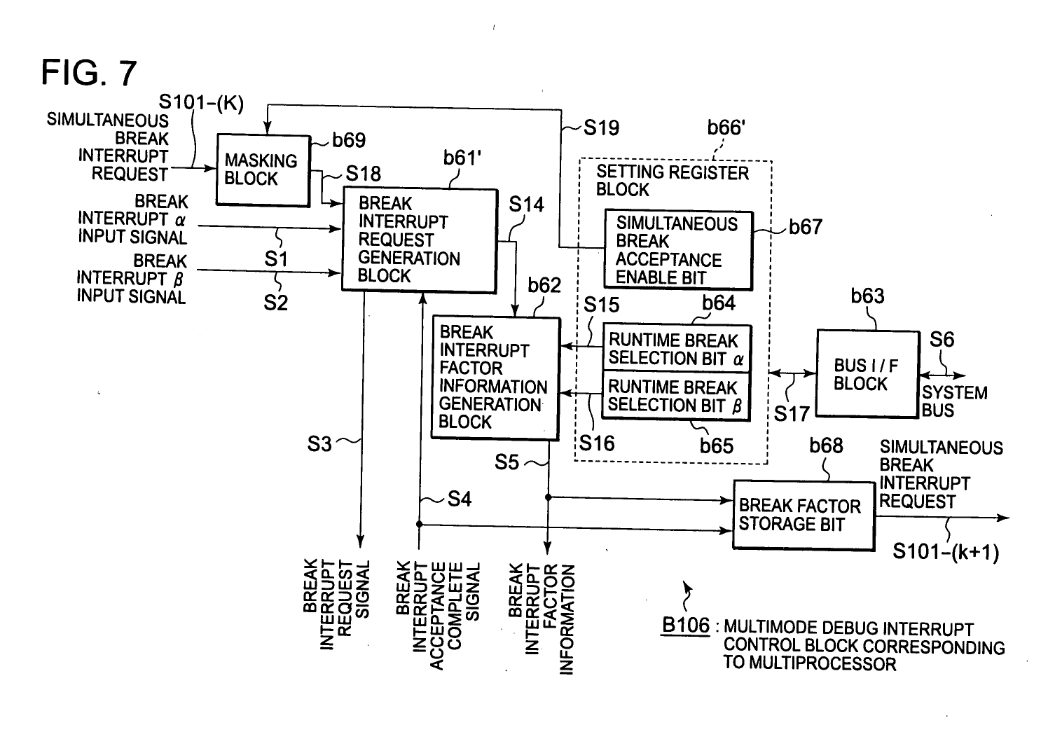

Each of the multimode debug interrupt control block (B106-1) and multimode debug interrupt control block (B106-2) in this second embodiment is provided with some functions in addition to those of the multimode debug interrupt control block (B106) in the first embodiment so as to correspond to a multiprocessor. FIG. 7 is a block diagram for describing the configuration of the multimode debug interrupt control block (B106) corresponding to a multiprocessor in this second embodiment. The multimode debug interrupt control blocks (B106-1) and (B106-2) corresponding to a multiprocessor respectively shown in FIG. 6 are the same in configuration and in function as the multimode debug interrupt control block (B106) shown in FIG. 7.

In FIG. 7, the break interrupt factor information generation block b62, the bus interface block b63, the runtime break selection bit α holding block b64 corresponding to the break interrupt α and the runtime break selection bit β holding block b65 corresponding to the break interrupt β are the same in function as those shown in FIG. 4.

The setting register block b66′ of the multimode debug interrupt control block (B106) corresponding to a multiprocessor includes a simultaneous break acceptance enable bit holding block b67 added newly thereto. The bit holding block b67 holds the simultaneous break acceptance enable bit written at the initialization time. This simultaneous break acceptance enable bit comes to have “1” in response to the acceptance of a simultaneous break interrupt and have “0” in response to the rejection of the interrupt.

The masking block b69 executes an AND operation of a simultaneous break interrupt input signal S101-(k) received from the processor in the preceding stage and a simultaneous break acceptance enable bit, then outputs a break interrupt input signal S18 when the AND condition is satisfied. When receiving a simultaneous break interrupt signal S101-(k) while the simultaneous break acceptance enable bit is “1”, the masking block b69 enables the simultaneous break interrupt and outputs a break interrupt input signal S18. If receiving a simultaneous break interrupt signal S101-(k) while the simultaneous break acceptance enable bit is “0”, the masking block b69 disables the simultaneous break interrupt and does not output the break interrupt signal S18.

In FIG. 7, the break interrupt request generation block b61′ has the function for accepting the break interrupt input signal S18 from the masking block b69 in addition to the function of the break interrupt request generation block b61. The break interrupt request generation block b61′, upon accepting a break interrupt input signal S18 from the masking block b69, outputs a break interrupt request signal S3 and a break interrupt type signal S14 that denotes the same debug mode as that specified by the simultaneous break interrupt input signal S101-(k). The break factor storage bit holding block b68 outputs a simultaneous break interrupt input signal S101-(k+1) to the processor in the next stage after confirming that the multimode debug interrupt control block (B106) accepts a break interrupt and the execution block goes into the break status. This simultaneous break interrupt input signal 5101-(k+1) is generated according to the break interrupt factor information S5 and includes the information that specifies a debug mode.

### <<Multiprocessor Operations>>

[Operations Executed when a Simultaneous Break Interrupt is Set and a Break Interrupt is Generated in the Processor B100-1]

1-1. It is premised here that the multimode debug interrupt control block (B106-1) in the processor 100-1 receives a break interrupt β input signal S2.

1-2. The break interrupt request generation block b61′ outputs a break interrupt request signal S3. Furthermore, the break interrupt request generation block b61′ outputs a break interrupt type signal S14 to the break interrupt factor information generation block b62. The signal S14 denotes that the break interrupt is generated by a break interrupt β input signal S2.

1-3. The break interrupt factor information generation block b62 outputs the break interrupt factor information S5 that specifies the normal debug mode according to the break interrupt type signal S14 and the runtime break selection bit β output signal S16. It is also premised here that “0” is set in the runtime break selection bit β just like in the first embodiment.

1-4. After this, if the execution block goes into the break status, the break interrupt request generation block b61′ receives a break interrupt acceptance complete signal S4.

1-5. The break factor storage bit holding block b68 generates information that specifies the normal debug mode according to the break interrupt factor information S5 and outputs a simultaneous break interrupt input signal S101-2 to the processor B100-2 synchronously with the break interrupt acceptance complete signal S4.

2-1. Then, the masking block b69 in the processor B100-2 receives a simultaneous break interrupt input signal S101-2. The masking block b69 thus executes an AND operation of the simultaneous break interrupt input signal S101-2 output from the processor B100-1 and the simultaneous break acceptance enable bit. If “0” is set in the simultaneous break acceptance enable bit, the masking block b69 masks the simultaneous break interrupt signal S101-2 and does not output the break interrupt input signal S18. On the other hand, if “1” is set for the simultaneous break acceptance enable bit, the masking block b69 enables the simultaneous break interrupt and outputs a break interrupt input signal S18.

2-2. Upon receiving the break interrupt input signal S18 from the masking block b69, the break interrupt request generation block b61′ outputs a break interrupt request signal S3. Furthermore, the break interrupt request generation block b61′ outputs a break interrupt type signal S14 to the break interrupt factor information generation block b62. The signal S14 denotes the same normal debug mode as that generated at the side of the processor B100-1.

2-3. The break interrupt factor information generation block b62 outputs the break interrupt factor information S5 that specifies the normal debug mode according to the break interrupt type signal S14 and the runtime break selection bit β output signal S16. It is premised here that “0” is set in the runtime break selection bit β just like in the processor B100-1.

2-4. After this, when the execution block goes into the break status, the break interrupt request generation block b61′ receives a break interrupt acceptance complete signal S4.

2-5. The break factor storage bit holding block b68 generates information that specifies the normal debug mode according to the break interrupt factor information S5, then outputs a simultaneous break interrupt input signal S101-1 to the processor B100-1 synchronously with the break interrupt acceptance complete signal S4.

3. Then, each of the processors B100-1 and B100-2 goes into the normal debug mode to process the simultaneous break interrupt.

### Effects of the Second Embodiment

In this second embodiment, the normal debug mode can be divided into some sub-modes so as to realize a simultaneous break debug mode that is indispensable in multiprocessor type computers.

What is claimed is:

1. A processor comprising:
a debug unit block that monitors an execution of a debug target user program and issues a debug interrupt when a debug condition is satisfied;
a multimode debug interrupt control block that specifies a debug mode for selecting a predetermined debug program upon receiving the debug interrupt; and
an execution block that selects a debug program and executes the debug program according to the debug mode specified by the multimode debug interrupt control block when the debug unit block issues the debug interrupt.

2. The processor according to claim 1,
wherein the execution block includes an address selection block that selects a first address for accessing a first debug program or a second address for accessing a second debug program according to the debug mode, and
wherein the execution block fetches an instruction from the address selected by the address selection block and executes the instruction.

3. The processor according to claim 2,
wherein the multimode debug interrupt control block includes a register that stores data used to set the correspondence between the debug interrupt and the predetermined debug program; and
wherein the control block, upon receiving the debug interrupt, refers to the register to specify a debug mode.

4. The processor according to claim 3,
wherein the debug unit block issues the first type debug interrupt when the first type debug condition is satisfied and the second type debug interrupt when the second type debug condition is satisfied, and
wherein the register of the multimode debug interrupt control block stores first data that relates the first type debug interrupt to the first debug program and second data that relates the second type debug interrupt to the second debug program.

5. The processor according to claim 4,
wherein the debug unit block, upon receiving the first type debug condition set by a user operation, issues a first type debug interrupt by assuming a debug condition to be satisfied in relation to the specific processing as the first type debug condition.

6. The processor according to claim 5,
wherein the execution block, if a debug mode is specified so as to select the second debug program and there is no certain time limit for switching to the second debug program, waits until a second type debug interrupt is issued and the second debug program is loaded, then executes the second debug program.

7. A multiprocessor system comprising:
A first and second processor, each of processors comprising:
a debug unit block that monitors an execution of a debug object program and issues a debug interrupt when a debug condition is satisfied;
a multimode debug interrupt control block that specifies a debug mode for selecting a predetermined debug program upon receiving the debug interrupt; and
an execution block that selects a debug program and executes the debug program according to the debug mode specified by the multimode debug interrupt control block when the debug unit block issues the debug interrupt,
wherein the multimode debug interrupt control block in the first processor, when a debug interrupt is issued in the first processor, specifies the same debug mode as that set in the first processor for the multimode debug interrupt control block in the second processor and sends a simultaneous break interrupt to the control block in the second processor so as to start the simultaneous break debug interrupt; and
wherein the multimode debug interrupt control block in the second processor, when receiving the specification of the same debug mode as that set in the first processor from the multimode debug interrupt control block in the first processor and receiving the simultaneous break interrupt, starts the debug interrupt in the second processor and specifies the same debug mode as that in the first processor for the execution block in the second processor.

8. The multiprocessor according to claim 7,
wherein the second processor includes a masking block that determines whether to enable the simultaneous break interrupt received from the first processor; and
wherein the second processor, when the masking block enables the simultaneous break interrupt, starts the simultaneous break interrupt in the second processor; and
wherein the second processor, when the masking block disables the simultaneous break interrupt, does not start the simultaneous break interrupt in the second processor.

9. A debugging method to be executed in a processor, comprising:
monitoring the execution of a debug target user program in the processor and starts a debug interrupt when a debug condition is satisfied;
specifying a debug mode used to select a predetermined debug program upon receiving the debug interrupt in the processor; and
selecting and executing the predetermined debug program according to the specified debug mode upon receiving a debug interrupt in the processor.

10. The debug method according to claim 9, wherein the executing of the predetermined debug program includes:
selecting a first address for accessing a first debug program or a second address for accessing a second debug program according to the debug mode so as to execute the predetermined debug program; and
fetching an instruction from the selected address.
